(19) United States
(12) Patent Application Publication
(10) Pub. No.: US 2003/0150061 A1
(43) Pub. Date: Aug. 14, 2003

(54) Independent foam cell surface and method of making same

(76) Inventor: David L. Farley, Anaheim Hills, CA (US)

Correspondence Address: STETINA BRUNDA GARRED & BRUCKER, 75 ENTERPRISE, SUITE 250, ALISO VIEJO, CA, 92656, US

(21) Appl. No.: 10/327,585

(22) Filed: Dec. 20, 2002

Related U.S. Application Data
(60) Provisional application No. 60/342,646, filed on Dec. 20, 2001.

(51) Int. Cl. A47C 27/14; B26D 3/00

(52) U.S. Cl. 5/736; 83/13

(57) ABSTRACT

An apparatus for reducing the occurrence of motion transfer across a bed when the apparatus is placed upon an independent coil construction mattress. The apparatus includes a substantially resilient pad having a size and shape substantially conforming to the size and shape of the mattress. The pad has a generally planar bottom surface sized and configured to lay upon the mattress further has an opposing load-bearing surface which defines a plurality of peaks extending therefrom. The load-bearing surface further defining a plurality of valleys extending between the load-bearing surface and the bottom surface. The peaks and valleys are arranged across the pad in a pattern to form a plurality of cells which depress independently of each other when pressure is exerted thereupon. A method of making the pad includes sandwiching a foam blank in-between two sacrificial sheets which are fed through two cylindrical rollers having protrusions formed thereon.

### CROSS-REFERENCE TO RELATED APPLICATIONS

This application claims the benefit of United States Provisional Application No. 60/342,646, filed Dec. 20, 2001, the entire contents of which are hereby incorporated by reference.

### STATEMENT RE: FEDERALLY SPONSORED RESEARCH/DEVELOPMENT

(Not Applicable)

### BACKGROUND OF THE INVENTION

The present invention generally relates to foam pads for supporting the human body and minimizing or eliminating the occurrence of motion transfer across the pad created by the movements of one individual which thereby results in detrimental disturbance to other individuals resting on the pad, or otherwise diminishes the general comfort or “feel” of any support surface beneath an individual.

In the field of sleep supports and more particularly in the field of mattresses, there are generally two major types of mattress constructions. The more traditional type involves the use of a plurality of coil springs which are disposed in some spaced apart relation to each other on a uniformly or centrally formed support base. This is generally referred to as open coil construction. Typically, an additional support base is provided which rests on top of the plurality of coils. In this configuration, each of the coil springs are connected to each other in some fashion due to the common support bases. Thus, when an individual rests on the mattress depressing a portion thereof, another portion of the mattress may then react and exhibit some signs of movement. For example, when a couple sleeps on such an open coil configuration mattress and a first partner tosses or turns while sleeping, the other partner may wake up due to being disturbed by the movements of the mattress created by the first partner. This effect is generally known as motion transfer and is considered a detrimental effect.

One solution to the reduction or elimination of motion transfer is the use of a foam pad integrally formed with a traditional open coil mattress, or placed on top of the open coil mattress. Specifically, convoluted and/or extracted foam pads have proven to be effective in reducing such motion transfer on open coil mattresses. Among other features of foam pads, the pads provide a barrier between the individual resting on the mattress and the open coils beneath. The foam pad absorbs a majority of the pressure and/or force exerted upon the mattress and reduces the occurrence of motion transfer. Additionally, a build-up of non-elastic fabric or other materials upon the open coils also tend to increase motion transfer. Therefore, the use of convoluted or extracted foam pads and the like are desirable to combat motion transfer in thicker upholstery build-ups.

Some mattress manufacturers (most notably the Simmons Mattress Company) have developed independent coil construction mattresses as another way to reduce or eliminate motion transfer. Such constructions are also known as pocketed coil systems. As understood, such mattresses incorporate coils which are disposed in independent chambers without any connection by a connected by a common base. The advantage of such a construction is that when one portion of the mattress is depressed, none of the surrounding areas of the mattress react due to the independent coil construction. Thus, the movements of a first partner might go undetected by the other partner resting on the same mattress due to absorption of the energy into the coils/pockets.

While the independent coil construction mattresses provide a generally effective system for reducing such motion transfer, the integration of foam padding to such mattresses has been increasingly desired to provide for enhanced comfort. Innovative coil systems are designed to generally minimize such things as motion transfer. However, one of the most important factors in a consumer's choice of mattresses is the ultimate comfort of the mattress. A build-up of fabric and/or pillow-tops placed upon the mattress may increase the plushness and overall comfort of the mattress. Similarly, the integration of foam pads also achieve a similar purpose. However, it is also apparent that there is a desire to incorporate foam padding into mattresses of all types. As a practical matter, while foam padding is generally very comfortable to lay upon, there are several other ways which foam padding may be utilized.

As is taught by U.S. Pat. No. 4,789,776, which was invented by the applicant and is hereby incorporated by reference, foam padding having pressure redistribution capabilities are highly desirable in redistributing body weight away from bony prominent areas which are most susceptible to the formation of pressure ulcers. Two of the primary causes of pressure ulcers are pressure and moisture. The pressure results from the supporting surface resisting the force of gravity on the body. For mattresses, this pressure is typically the highest beneath the shoulder (the scapulae) and tail (sacrum and trochanter), generally the areas of greatest mass and projection. In these high pressure areas, the pressure against the body can be sufficient to occlude the capillaries and lymph vessels, thereby preventing the circulation of oxygen and nutrients to the skin. In addition, because airflow over these skin areas is typically prevented due to the surface of the mattress, greater amounts of moisture are excreted for the dissipation of heat and waste. Over a sufficient period of time, the combination of high pressure and moisture will lead to the formation of pressure ulcers. Thus, foam padding has proven to be effective in the preventing of such ulcers.

However, the use of such foam pads with independent pocketed coil system mattresses has resulted in detrimental effects. While one of the primary objects of the independent pocketed coil system is to reduce the occurrence of motion transfer across the mattress, the addition of a foam padding actually tends to destroy the object of the independent pocketed coil system. Specifically, integrating foam padding into such a mattress or placing it on top of such a mattress actually creates motion transfer. While the coils may be independently formed to absorb force, pressure and/or shock, the foam padding is ultimately placed on top of the coil system. Thus, when an individual places pressure upon an area of the pad, that particular portion of the pad is depressed and the underlying coil chambers are compressed as well. However, motion transfers to other areas of the foam padding since only the particular depress portion of the pad and the underlying chambers are compressed. Thus, while the independent pocketed coil system may be generally effective in reducing motion transfer, the addition of a foam padding frustrates the object of the system by creating such motion transfer.

The manufacture of foam pads continues to largely follow the methods taught by U.S. Pat. No. 3,431,802, which patent is hereby incorporated by reference. The pads are typically formed by feeding a foam block between two cooperating parallel cylinders, each of which has a undulated surface. The cylinders rotate towards one another and are spaced so that the block inserted between them is compressed between the cylinders and is driven against a cutting edge which slices the block in half. Each half generally comprises alternating rows of peaks and valleys, in checkerboard fashion. The resulting halves are perfectly matched so that when one half is laid upon the other, the tops of the peaks of one half rest against the floor of the valleys of the other half forming a solid block. In addition, although it is possible to manufacture pads which are not the mirror image or reflection of one another, this is rarely done, as it would typically result in only one usable half, thereby significantly increasing material costs. For example, in the manufacturing of a typical convoluted foam pad, a foam block having a particular thickness would be provided. If a foam block having a thickness of 3 inches is provided, two substantially mirroring foam pads having a thickness of 2 inches would be formed (measured from the top of a peak to the bottom of the foam pad).

Accordingly, there is a need for extracted foam pads for use with independent coil systems which reduce the occurrence of motion transfer across the pad. The present invention addresses such need by providing an extracted independent pocketed foam cell pad for use with such independent coil systems and a novel method of making the same.

### BRIEF DESCRIPTION OF THE DRAWINGS

These as well as other features of the present invention will become more apparent upon reference to the drawings wherein:

FIG. 1 is an illustration of the independent foam cell pad made according to the present invention;

FIG. 1A is a cross-sectional view of the pad taken along lines 1A-1A of FIG. 1;

FIG. 2 is perspective view of the pad illustrating the peaks and valleys thereof formed on the load-bearing surface thereof;

FIG. 3 is a plan view illustrating the stacking of the sacrificial sheets with the foam blank prior to extraction;

FIG. 4 is a plan view illustrating the pre-extraction blank being inserted in-between the cylinders and being simultaneously cut by the cutting edge positioned adjacent thereto; and

FIG. 5 is plan view illustrating the resulting product formed after the pre-extraction blank is fed through the cylinders and the sacrificial sheets are removed therefrom.

### BRIEF SUMMARY OF THE INVENTION

The present invention specifically addresses and alleviates the above-identified deficiencies in the art. In this regard, there is provided an elongated extracted foam pad for reducing the incidence of motion transfer across a mattress. The pad made according to the present invention alleviates the deficiencies in the prior art by providing a surface which absorbs energy, pressure, and shock in the individual cells to reduce the incidence of motion transfer across the pad. Preliminary tests have shown that an independent coil system mattress having the independent foam pad made according to the present invention integrated therein or placed thereon has a reduction of 15% in motion transfer as compared to an independent coil system mattress having a standard foam pad.

It has been observed that in furniture, bedding and other consumer home textile product applications, visco-elastic foams are used to create tactile, easily deforming, thermally responsive and motion-dampening surfaces which can be measured and compared in terms of these physical characteristics. The characteristic “feel” of these products is frequently described as being “highly compliant” or “moldable to one's shape.” Disadvantageously, visco-elastic foams are on the order of two to six times more expensive per unit volume than traditional urethane foams which are highly resilient as opposed to easily deforming. Additionally, the visco-elastic foams are not significantly affected by changes in temperature and are producers of increased levels of surface tension and motion transfer. By applying the method as set forth in the present invention to traditional urethane foams, motion dampening characteristics of more expensive visco-elastic foams are mimicked. This results from the highly separated or open surface design which significantly diminishes tension across the product surface.

The pad and method of forming the same according to the present invention additionally enhances the tactile function of visco-elastic foams and most obviously, their motion dampening function due to the significant reduction in load bearing materials (extracted) which improves the ease of deformation and time reaction to temperature change in the working application. Therefore, the pad provides ameans to simulate and enhance the performance of the visco-elastic foams at a significantly reduced cost to the consumer. It is also possible to laminate the foam blank (as opposed to the sacrificial foam sheet) in the form of a three-layered combination traditional/visco-elastic/traditional foam laminate which will produce a foam pad of thickness greater than half the thickness of the pre-extraction foam blank, which is generally made up of visco-elastic foam on its top surface only with an underlying foundational base of traditional foam. This allows for a balance of true visco-elastic foam “feel” and performance at a significantly reduced cost to the consumer.

The present pad and method of making the same creates additional economies to the consumer as it produces products of greater thickness (loft) from the foam blank which is cut in half; a thicker dimension than half of the block thickness. Convoluted foam generally can be used to render a foam block into two mirror image foam sheets. These foam sheets have a resulting peak height thickness of greater than half the initial foam blank thickness. The additional peak height and the connecting valley thickness of such a convoluted foam always equals the thickness of the initial foam blank. However, the present pad and method creates a resulting foam product pad having a thickness greater than half of the initial foam blank, but without any base thickness owing to apertures. Depending on the design part and laminate thicknesses, it is possible that the thickness (loft) can be improved to completely cover the cost of the sacrificial foam sheet which can be made from virtually any lower or non-specification foam grade, as it generally does not end up in the finished product.

Advantageously, it has been determined that pads fabricated totally, or in part, from visco-elastic materials (or any other of the significantly expensive upholstery polymer or natural product filler materials such as Latex and other equivalents known in the art) can be produced at a lower cost per measure of product thickness than half of the cost of the initial foam blank.

Additionally, the pad formed according to the present invention provides a “picture frame” or comfort border of uninvolved foam which may be desirable for edge support in bedding and seating applications. Such comfort border may be created in any combination of useful widths ranging from about 1 to about 6 inches.

Therefore, the present invention provides an apparatus for reducing the occurrence of motion transfer across a bed when the apparatus is placed upon an independent coil construction mattress. The apparatus includes a substantially resilient pad having a size and shape substantially conforming to the size and shape of the mattress. The pad has a generally planar bottom surface sized and configured to lay upon the mattress further has an opposing load-bearing surface which defines a plurality of peaks extending therefrom. The load-bearing surface further defining a plurality of valleys extending between the load-bearing surface and the bottom surface. The peaks and valleys are arranged across the pad in a pattern to form a plurality of cells which depress independently of each other when pressure is exerted thereupon.

The present invention additionally provides a method making independent foam cell surfaces. The method includes selecting at least three resilient members, the at least three resilient members including two sacrificial sheets and a foam blank. A pre-extraction blank is formed by stacking the at least three resilient members on top of each other such that the foam blank is positioned between the two sacrificial sheets. Two cylindrical rollers are provided which define a plurality of peaks extending radially therefrom. The peaks are disposed in spaced-apart relation such that a plurality of valleys are formed therebetween. Each of the peaks are arranged in generally equidistant relation so as to form a pattern. The two cylindrical rollers are positioned adjacent each other such that rotation of the rollers in opposing directions aligns the peaks on one of the rollers to insert into the valley of another one of the rollers. The pre-extraction blank is fed in-between the rollers such that the rollers apply force upon the first and second sacrificial sheets to depress portions thereof. A cutting edge is disposed adjacent the rollers. The cutting edge is applied to the pre-extraction blank as the pre-extraction blank passes through the rollers. The two sacrificial blanks are removed from the pre-extraction blank.

### DETAILED DESCRIPTION OF THE PREFERRED EMBODIMENT

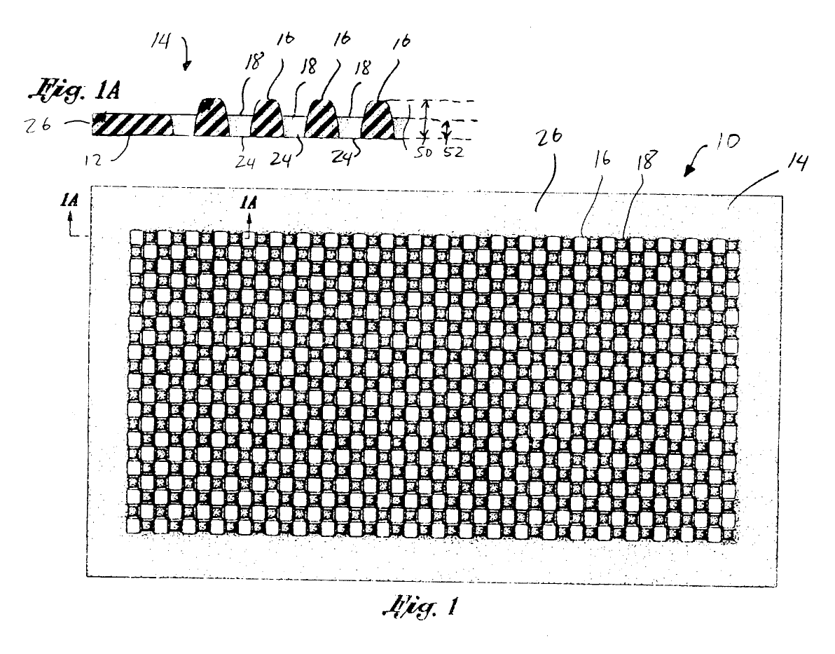

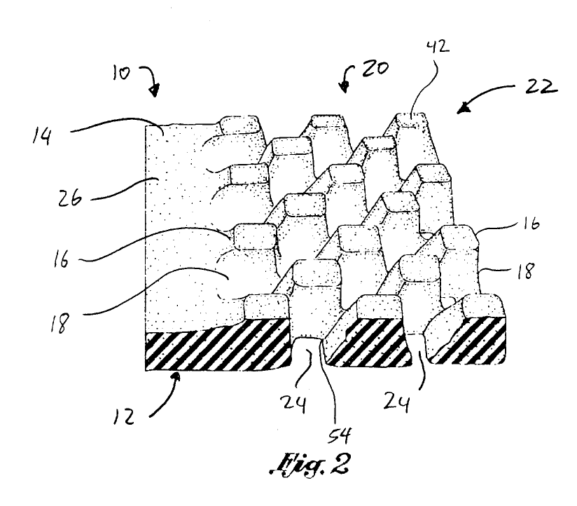

One of the primary objects of the present invention is to reduce the motion transfer across independent coil system mattresses. In this respect, an apparatus for reducing the occurrence of motion transfer across a bed when the apparatus pad is placed upon an independent coil construction mattress is provided. As shown in FIGS. 1, 1A and 2, the apparatus includes a substantially resilient pad 10 having a size and shape substantially conforming to the size and shape of the mattress. The pad 10 has a generally planar bottom surface 12 sized and configured to lay upon the mattress further has an opposing load-bearing surface 14 which defines a plurality of peaks 16 extending therefrom. The load-bearing surface 14 further defining a plurality of valleys 18 extending between the load-bearing surface 14 and the bottom surface 12 to form a lofted interface surface 20 thereacross. The peaks 16 and valleys 18 are arranged across the pad 10 in a pattern to form a plurality of cells 22 which depress independently of each other when pressure is exerted thereupon.

The pad 10 is preferably a rectangular shape substantially conforming to the shape of a mattress. The planar bottom surface 12 and the opposing load-bearing surface 14 preferably define a comfort border 26 therebetween. The comfort border 26 is formed about an outer periphery of the pad 10 so as to enclose the plurality of cells in a center portion thereof. Preferably the comfort border 26 should extend inwards from each edge of the pad 10 and toward the center of the pad 10 as shown in FIG. 1. The comfort border 26 may surround a plurality of peaks 16 and valleys 18 which are disposed in a substantially checker-board fashion throughout a center portion of the pad 10. The peaks and valleys 16 and 18 define a lofted interface surface 20, i.e., the resulting pad 10 thickness is greater than one-half of the initial pre-extraction foam blank 34 thickness. With the novel technique of the present invention, it is possible to optimize the loft to produce two full foam blank 32 thickness products from each pre-extraction foam blank 34. For example, a 3 inch foam blank 32 can be made to produce two 3 inch thick pads 10 exceeding even the economic loft potential for conventional convoluted foam products. Furthermore, the comfort border 26 provides edge support which is desirable in adding to the overall comfort of the bed and additionally provides firmness when getting up from the bed. The thickness between the bottom planar surface 12 and the peaks 16 is preferably about 1 and a half inches. However, the size of the peak 16 may vary according to needs and depending upon the thickness of the original foam blank from which the pad 10 is manufactured. The peaks 16 are preferably formed having a substantially truncated conical or truncated square-pyramidal shape as more particularly shown in FIG. 2. More specifically, the shape of the peak 16 may generally cube-shaped and tapers toward the load-bearing surface 14 of the pad 10 yet has rounded edges like a conical shape. Each peak preferably defines a substantially flat planar portion 42 which is advantageous in optimally receiving loads thereupon. It is recognized that differing shapes and sizes of the peaks 16 and valleys 18 may be utilized which accomplish the same purpose. When the pad 10 is viewed from a side profile, it is apparent that the pad's peaks 16 have a greater thickness than the comfort border 26. Advantageously, the increased thickness of the peaks 16 in comparison to the comfort border 26 creates the lofted interface surface 20 upon the load-bearing surface 14 to provides comfort to individuals resting thereupon. As shown in FIG. 1A, preferably, the comfort border thickness 52 is approximately one-half of the initial pre-extraction foam blank thickness 32 or the peak 16. Even more preferably, the comfort border 26 is formed having a uniform comfort border thickness 52 between the planar bottom surface 12 and the opposing load-bearing surface 14.

The valleys 18 of the pad 10 are formed as apertures disposed between each peak 16. Thus, the peak 16 and valley 18 configuration is a substantially checker-board layout with peaks 16 and valleys 18 alternating through the center portion of the pad 10. The valleys 18 are formed having the same size and shape of the peaks 16. As will be further described below, in the manufacturing process, two pads 10 made according to the present invention are formed such that each peak 16 on one pad 10 substantially corresponds to each valley 18 on another pad 10. The valleys 18 are further formed such that apertures 24 are formed by each valley 18. Thus, when viewing the bottom planar surface 12 of the pad 10, a plurality of substantially square apertures 18 disposed in spaced relation to each other may be apparent. Preferably, each peak 16 is connected to each other peak 16 via substantially thin membranes 54. Thus, the combination of peaks 16 and valleys 18 forms substantially conical cells 22 connected by such thin membranes 54. However, it is anticipated that the size and shape of the peaks 16 and valleys 18 may be varied. Moreover, it is also contemplated that the height of each peak 16 may be varied according to needs. The apertures 24 on the bottom planar surface 12 of the pad 10 form valleys 18 extending into either of two sacrificial foam sheets 30.

Advantageously, the cells 22 deliver support with elasticity to create a lofted interface surface 20 that conforms and envelopes the body when an individual rests on the pad 10. Each conical or square-pyramidal shaped peak 16 cooperates with the valleys 18 to form the cells 22 and performs superior independent action without any surface connection to prevent the incidence of motion transfer across the pad 10. When the pad 10 is placed upon the independent coil system, the lofted interface surface 20 acts in conjunction with the independent coil mattress to provide a high-point elasticity as opposed to an area elasticity. Simply put, each cell 22 compresses and reforms individually without affecting remotely connected cells 22. The combination of compression gain and high-point elastic behavior leave individuals resting upon the pad 10 more fully immersed in the cushioning surface. With the addition of the pad 10 to the independent coil mattress, the individual resting upon the pad 10 is placed in close relation to the coils reducing the detrimental effects of hammocking and allowing the physics of the coil system to operate at peak levels. The pad 10 also advantageously more fully envelopes the individual in the pad 10 and generally increases the performance of the pad's 10 reduction in motion transfer. The synergy achieved between the cushioning and coil surfaces results in a reduction in motion transfer and increased motion dampening in both firm and soft foam. Additionally, a greater amount of cradling and pressure relief is provided which reduces the overall amount of night-time movements which normally detract from the individual's ability to sleep comfortably. The pad's 10 open construction allows for measurable air flow and heat dissipation creating a cooler sleeping surface. As previously described, the pad 10 is lofted which reduces thickness/fill rate economics as compared to flat foam.

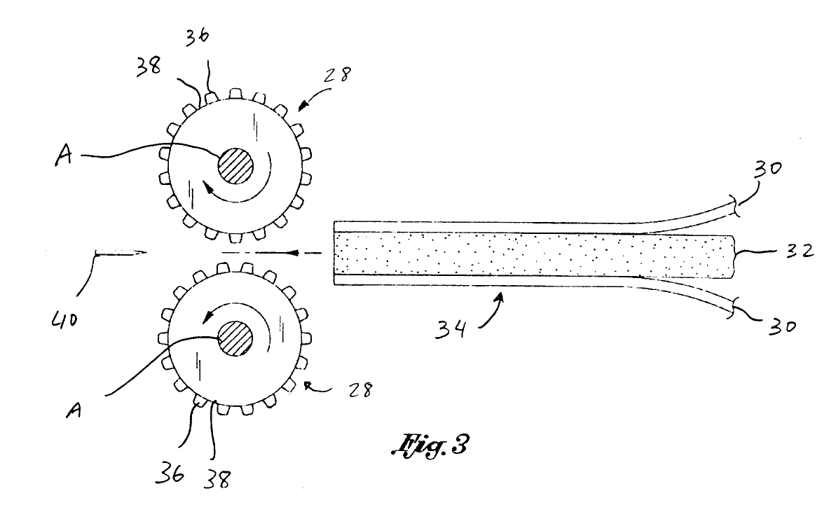

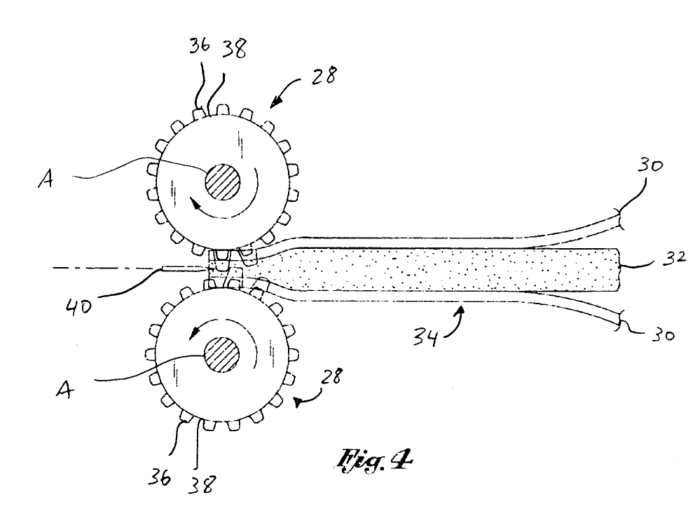

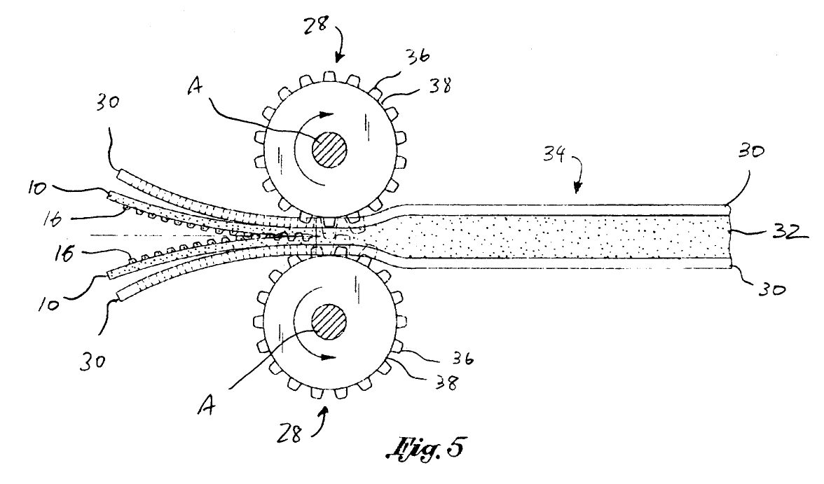

There is also provided a novel method of manufacturing the independent cell pad 10 made according to the present invention. As shown in FIGS. 3-5, in manufacturing the pad 10, there is first provided a foam blank 32 which is preferably rectangularly shaped and has a thickness in the range of from about one-half to about 10 inches, and a width in the range of from about 30 to about 80 inches. The foam blank 32 is then disposed between two sacrificial foam sheets 30 which are the same length and width as the foam blank 32 and further have a thickness in the range of from about ½ to about 2 inches, and a width in the range of from about 30 to about 80 inches. Thus, the foam blank 32 would appear to be “sandwiched” between the two sacrificial foam sheets 30 such that a sacrificial foam sheet 30 is disposed on top of the load-bearing surface 14 of the foam blank while another sacrificial foam sheet 30 is disposed beneath the bottom planar surface 12 of the foam blank 32. The combination of the foam blank 32 and the sacrificial foam sheets 30 forms a pre-extraction blank 34 which is fed into two cooperating parallel cylindrical rollers 28. Each of the rollers 28 has a plurality of roller peaks 36 extending therefrom which are sized and shaped as previously described above in relation to the peaks 16 and valleys 18, e.g. substantially conically shaped. However, it should be noted that alignment of the roller peaks 36 are positioned such that the the roller peaks 36 create the peaks 16 on one pad 10 while simultaneously creating the valley 18 of another pad 10. The roller peaks 36 are disposed on the rollers 28 in an alternating fashion. The rollers 28 rotate toward one another about an axis of rotation A so that when the pre-extraction blank 34 is fed into the rollers 28, the pre-extraction blank 34 is compressed therebetween. When viewed from a side profile, the pre-extraction blank 34 appears to have portions being squeezed up with alternating portions being squeezed down. A single cutting edge 40 is presented to the squeezed foam to slice the pre-extraction foam blank 34 in half to create two lofted foam pads 10. These lofted foam pads 10 may be further cut into thinner thickness dimensions. Because the rollers 28 are squeezing portions of the pre-extraction foam blank 34 both upwards and downwards, when the cutting edge 40 slices the pre-extraction foam blank 34 in half, the resulting pad 10 is formed having the checker-board formation with peaks 16 and valleys 18 as described above in relation to the pad 10. However, it is contemplated that other patterns of formation may be created by altering the layout of the roller peaks 36.

Advantageously, the sacrificial sheets 30 are reusable after passing through the rollers 28. Since the sacrificial foam sheets 30 are used to provide a surface against which the pre-extraction foam blank 34 is cut, the sacrificial foam sheets 30 may be used more than once by reversing the same to reform another pre-extraction foam blank 34. The reusability of the sacrificial foam sheets 30 reduces overall manufacturing costs by reducing the cost of sacrificial foam sheets 30 which are used solely for the manufacturing process.

Additional modifications and improvements of the present invention may also be apparent to those of ordinary skill in the art. Thus, the particular combination of parts described and illustrated herein is not intended to serve as limitations of alternative devices within the spirit and scope of the invention.

What is claimed is:

1. An apparatus for reducing the occurrence of motion transfer across a bed when the apparatus is placed upon an independent coil construction mattress, the apparatus comprising:
a substantially resilient pad having a size and shape substantially conforming to the size and shape of the mattress, the pad having a generally planar bottom surface sized and configured to lay upon the mattress, the pad further having an opposing load-bearing surface which defines a plurality of peaks extending therefrom, the load-bearing surface further defining a plurality of valleys extending between the load-bearing surface and the bottom surface to form a lofted interface surface thereacross, the peaks and valleys being arranged across the pad in a pattern to form a plurality of cells which depress independently of each other when pressure is exerted thereupon.

2. The apparatus of claim 1 wherein the valleys extend completely between the planar bottom surface and the opposing load-bearing surface to define an aperture therethrough.

3. The apparatus of claim 2 wherein the pattern is a checkerboard formation.

4. The apparatus of claim 1 wherein the pad is fabricated from a urethane foam.

5. The apparatus of claim 1 wherein the pad is fabricated from a combination of urethane foam and Visco-elastic foam.

6. The apparatus of claim 1 wherein pad is substantially rectangular-shaped.

7. The apparatus of claim 1 wherein the planar bottom surface and the opposing load-bearing surface define a comfort border therebetween, the comfort border being formed about a periphery of the pad so as to enclose the plurality of cells in a center portion thereof.

8. The apparatus of claim 7 wherein the comfort border is formed having a uniform comfort border thickness between the planar bottom surface and the opposing load-bearing surface.

9. The apparatus of claim 8 wherein the plurality of peaks are formed having a peak thickness between the planar bottom surface and the opposing load-bearing surface, the peak thickness being greater than the comfort border thickness to form the lofted interface surface across the load-bearing surface.

10. The apparatus of claim 1 wherein the plurality of peaks are formed having truncated conical portions interconnected together at a base thereof.

11. The apparatus of claim 1 wherein the plurality of peaks are formed having truncated square-pyramidal portions interconnected together at a base thereof.

12. A method of making independent foam cell surfaces, the method comprising the steps of:
a) selecting at least three resilient members, the at least three resilient members including two sacrificial sheets and a foam blank;
b) forming a pre-extraction blank by stacking the at least three resilient members on top of each other such that the foam blank is positioned between the two sacrificial sheets;
c) providing two cylindrical rollers, each of the rollers defining a plurality of roller peaks extending radially therefrom, the roller peaks being disposed in spaced-apart relation such that a plurality of roller valleys are formed therebetween, each of the roller peaks being arranged in generally equidistant relation so as to form a pattern;
d) positioning the two cylindrical rollers adjacent each other such that rotation of the rollers in opposing directions aligns the roller peaks on one of the rollers to insert into the roller valley of another one of the rollers;
e) feeding the pre-extraction blank in-between the rollers such that the rollers apply force upon the first and second sacrificial sheets to depress portions of the foam blank thereof;
f) providing a cutting edge disposed adjacent the rollers;
g) applying the cutting edge to the pre-extraction blank as the pre-extraction blank passes through the rollers; and
f) removing the two sacrificial blanks from the pre-extraction blank.

13. The method as in claim 12 wherein the foam blank is fabricated from a urethane foam.

14. The method as in claim 12 wherein the foam blank is fabricated from a combination of urethane foam and visco-elastic foam.

15. The method as in claim 12 wherein the peaks are formed having truncated conical portions.

16. The method as in claim 12 wherein the peaks are formed having truncated square-pyramidal portions.

17. The method as in claim 12 wherein the pattern is a checkerboard formation.

18. The method as in claim 12 wherein the cutting edge is disposed in-between the rollers adjacent a point of engagement between the sacrificial sheets, the foam blank, and the rollers.

19. The method as in claim 18 wherein the cutting edge is an elongated knife extending substantially parallel with respect to the cylinders' axis of rotation.

20. The method as in claim 12 wherein step d) further comprises the step of aligning the rollers such that the peaks on each of the rollers depress the foam blank to a depth necessary to form apertures therethrough.

21. The method as in claim 12 further comprising the step of:
g) revealing two individual foam pads having a plurality of peaks and valleys disposed thereon.
